(19) United States
(12) Patent Application Publication
(10) Pub. No.: US 2013/0206536 A1
(43) Pub. Date: Aug. 15, 2013

(54) MAIN BODY FOR A SAFETY COUPLING

(71) Applicants: Andreas Rimpel, Moenchberg (DE); Michael Woeber, Woerth (DE); Tobias Wolf, Erlenbach am Main (DE)

(72) Inventors: Andreas Rimpel, Moenchberg (DE); Michael Woeber, Woerth (DE); Tobias Wolf, Erlenbach am Main (DE)

(73) Assignee: R + W ANTRIEBSELEMENTE GMBH, Klingenberg (DE)

(21) Appl. No.: 13/809,651

(22) PCT Filed: Jul. 8, 2011
(86) PCT No.: PCT/EP11/03404

§ 371 Date: Mar. 4, 2013

(30) Foreign Application Priority Data
Jul. 12, 2010 (DE) 10 2010 026 951.4

(51) Int. Cl. F16D 7/08

(52) U.S. Cl. CPC F16D 7/08
USPC 192/56.1

(57) ABSTRACT

A device including an aluminum main body for a safety coupling is used for connection of at least one shaft and a drive wheel by way of, for example, a clamping hub. The device includes additional metal parts, namely a mounting flange, which is supported on the main body via ball bearings and is rotatable relative to the main body. One end face of the mounting flange can be connected to the shaft or the drive wheel in a non-positive manner, and the other end face of the mounting flange has indentations. Other additional parts include a steel bearing ring which secures the ball bearings on the outside of the main body via a retaining ring, locking balls disposed in the indentations, and an aluminum actuator ring which presses the locking balls in the direction of the indentations with force adjustable by an adjusting nut.

The invention relates to a main body for a safety coupling.

Such main bodies for a safety coupling used for the non-positive connection of two shafts by way of a keyway, claws, a metal bellows, and/or clamping hub(s) are known in a plurality of embodiments. The principle, if overload occurs, for the non-positive connection between the two shafts, to release the locking balls from the indentations in the mounting flange against the force of the spring designed as a disk spring is also known (DE 197 39 469 A1). The use of claws, optionally with a so-called elastomeric crown on the main body, is also known (DE 10 2006 050 995 A1).

The disadvantage of these known main bodies, including the additional parts, is that they are all made of steel and are therefore naturally heavy, thereby greatly limiting the use of these known main bodies, including additional parts, for safety couplings.

The object of the invention is to design a main body, including additional parts, to be considerably more lightweight while ensuring that the coupling formed thereof is equally safe.

This object is achieved according to the invention by the subject matter of claim 1, that is, by a main body made of metal for a safety coupling used for the direct or indirect connection of at least one shaft and a drive wheel, for example a sprocket or toothed belt wheel, by way of a keyway, claws, a metal bellows, and/or clamping hub(s), comprising additional metal parts, namely a mounting flange, which is supported on the main body via ball bearings and is rotatable relative to the main body. One end face of the mounting flange can be connected to the one shaft in a non-positive manner, and the other end face of the mounting flange has indentations, a bearing ring, which secures the ball bearings on the outside of the main body via a retaining ring, locking balls disposed in the indentations, and an actuator ring, which acts on the locking balls and presses the locking balls in the direction of the indentations due to the force of a spring preferably designed as a disk spring and thus establishes a form-fit connection to the main body, which can be connected to the other shaft, wherein the force of the spring can be adjusted by way of an adjusting nut (which can be rotated on an external thread disposed on the jacket of the main body), wherein at least the bearing ring is made of steel as the metal and at least the main body and the actuator ring are made of aluminum as the metal.

A safety coupling according to the invention produced for this main body, including additional parts, is not only much more lightweight, it also conducts heat well, is electrically insulating, and is much quieter upon engagement and disengagement, all without affecting the lifetime strength or the accuracy. In sum, a more lightweight, more compact, and stronger safety coupling therefore results. By virtue of the invention, a weight reduction of at least 50%, and up to 60%, compared to the standard product line can be achieved. For example, a safety coupling for torque limitation of up to 160 Nm has a dead-weight of only 370 grams and a mass moment of inertia of 0.8*10^{*3} kgm². This ratio of torque output to dimensions and weight is currently unattainable in the prior art and is therefore unique.

In addition, if the steel is heavy-duty and hardened, it is possible to use parts that are thinner and, therefore, more lightweight without reducing the loadability of the safety coupling produced therewith. The same substantially applies if the aluminum is not cast, but rather is forged, thereby resulting in a more compressed structure and, simultaneously, relatively greater toughness combined with low weight.

The surface coating of the forged aluminum, the so-called HCGL coating (Hart Coat Glatt), smooths and reinforces the surface, and therefore results in greater wear resistance at the points loaded by the ball bearings and locking balls, and in maximum corrosion resistance (of more than 2000 h in the salt spray chamber).

The mounting flange, the actuator ring, and/or the adjusting nut are preferably made of aluminum, while the locking balls, the ball bearings, and/or the retaining ring are made of steel. Therefore, it is essential to the concept according to the invention that at least the main body and the additional parts are made of aluminum, and at least the bearing ring and, optionally, the locking balls, the ball bearings, and/or the retaining ring are made of steel, and these are used for a safety coupling.

A compact design advantageously results when the mounting flange is simultaneously designed as a bearing cage for the ball bearings.

Given that the mounting flange is disposed radially entirely outwardly, separated from the main body via the ball bearings and rotationally symmetrically with respect to the main body, a very rigid design advantageously results.

Further features of the invention are characterized in the dependent claims,

An exemplary embodiment of the invention is explained in greater detail in the following with reference to the drawing. Shown therein:

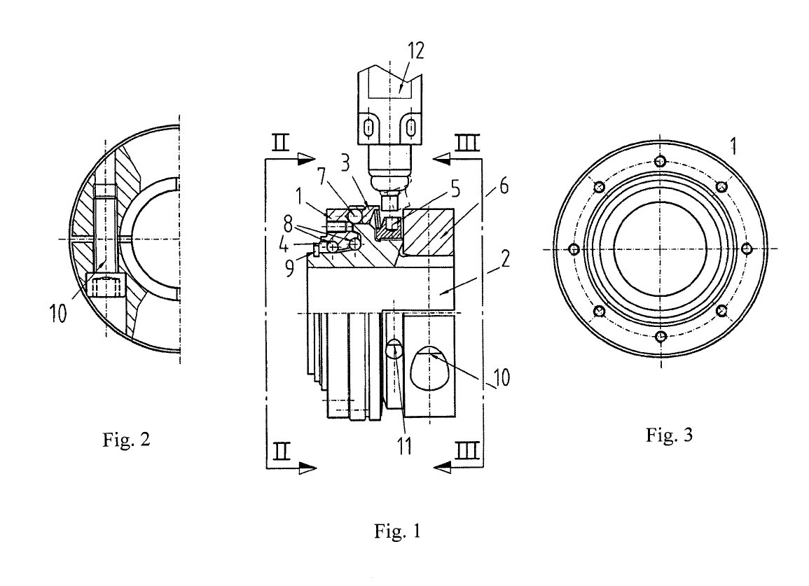

FIG. 1 shows the main body including additional parts, in a schematic half-sectional view;

FIG. 2 shows a front view II-II according to FIG. 1; and

FIG. 3 shows a rear view III-III according to FIG. 1.

The main body 2 shown in FIG. 1 is made of metal and is used for the direct or indirect connection of at least one shaft and a drive wheel, for example a sprocket or toothed belt wheel. In the exemplary embodiment shown; a clamping hub 6 for a safety coupling is provided on the one end face of the main body 2.

The main body 2 is equipped with additional parts that are metallic, namely a mounting flange 1, which is supported on the main body 2 via ball bearings 8 and is rotatable relative to the main body, wherein one end face of the mounting flange can be connected to the shaft or the drive wheel in a non-positive manner, and the other end face of the mounting flange has indentations. This (2) is further equipped with a bearing ring 4 securing the ball bearings 8 on the outside of the main body via a retaining ring 9, and is equipped with locking balls 7 disposed in the indentations.

Finally, the main body comprises an actuator ring 3, which acts on the locking balls 7 and presses the locking balls in the direction of the indentations due to the force of a spring preferably designed as a disk spring and thus establishes a form-fit connection to the main body, which can be connected to the shaft or the drive wheel, wherein the force of the actuator ring 3 being adjustable via an adjusting nut 5, wherein at least the bearing ring 4 and, optionally, the locking balls 7, the ball bearings 8, and/or the retaining ring 9 are made of a heavy-duty and hardened steel as the metal, and at least the main body 2 and the actuator ring 3, and, optionally, the mounting flange 1, the actuator ring 3, and/or the adjusting nut 5 are made of forged, and, optionally, surface-coated aluminum.

The mounting flange 1 is simultaneously designed as a bearing cage for the ball bearings 8 and is disposed radially outwardly, separated from the rotationally symmetrical main body 2 via the ball bearings 8 and rotationally symmetrically with respect to the main body.

1. A device for a safety coupling comprising a main body, mounting flange supported on the main body by ball bearings and rotatable relative to the main body, one end face of the mounting flange being connectable to a shaft or a drive wheel and another end face of the mounting flange having indentations, a bearing ring securing the ball bearings an exterior of the main body via a retaining ring, locking balls an actuator ring, a spring, which acts on the actuator ring to cause the actuator ring to press the locking balls into the indentations thereby to connect the flange to the main body, and an adjusting nut for adjusting force with which the spinet acts on the actuator ring, and wherein at least the bearing ring is made of a steel, and at least the main body and the actuator ring are made of aluminum.

2. The device according to claim 1, wherein the steel is heavy-duty hardened steel and/or the aluminum is forged aluminum.

3. The device according to claim 2, wherein the forged aluminum is surface-coated.

4. The device according to claim 1, wherein at least one of the mounting flange, and the adjusting nut is made of aluminum.

5. The device according to claim 1, wherein at least one of the locking balls, the ball hearings, and the retaining ring is made of steel.

6. The device according to claim 1, wherein the mounting flange comprises a bearing cage for the ball bearings.

7. The device according claim 1, wherein the mounting flange and the main body have a common axis about which the mounting flange is symmetrical, and the ball bearings extend radially inwardly from a radially inner periphery of the mounting flange and. radially space said inner periphery from the main body.

8. A device according to claim 1, wherein the spring is a disc spring.
